(19) United States
(12) Patent Application Publication
(10) Pub. No.: US 2010/0190494 A1
(43) Pub. Date: Jul. 29, 2010

(54) Method and apparatus for cell selection

(75) Inventor: Kyung Jun Lee, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/657,712

(22) Filed: Jan. 26, 2010

(30) Foreign Application Priority Data
Jan. 28, 2009 (KR) 10-2009-0006469

(51) Int. Cl. H04W 48/20

(52) U.S. Cl. 455/434

(57) ABSTRACT

A portable terminal is capable of selecting a cell for connecting to a communication network. The portable terminal sets a specific cell that satisfies preset conditions among surrounding cells as a management cell. The portable terminal determines whether a cell selection or cell reselection event is generated. The portable terminal performs a cell selection procedure excluding the management cell when the cell selection or cell reselection event is generated.

### CROSS-REFERENCE TO RELATED APPLICATION(S) AND CLAIM OF PRIORITY

The present application is related to and claims the benefit under 35 US.C. §119 (a) of a Korean patent application filed in the Korean Intellectual Property Office on Jan. 28, 2009 and assigned Serial No. 10-2009-0006469, and the entire disclosure of which is hereby incorporated by reference.

### TECHNICAL FIELD OF THE INVENTION

The present invention relates to a method and apparatus for selecting a cell, and more particularly, to a method and apparatus for selecting a cell, which can reduce a phenomenon that a portable terminal temporarily falls into a no-service state and can minimize the current consumption of a battery.

### BACKGROUND OF THE INVENTION

Generally, in a communication system, if the power of a portable terminal is turned on, the portable terminal selects a specific cell and camps on the cell. This is called a cell selection procedure. The cell represents a communication service area that can be uniquely distinguished for a portable terminal.

The cell selection procedure is a process that a portable terminal tries to find a suitable cell of the base station to camp on whenever a new base station is selected. The base station may be a public land mobile network (PLMN) or the like. In the cell selection process, a portable terminal can set a cell whose reception signal intensity is highest as a serving cell, and can camp on the serving cell. Further, in case an error occurs in a wireless path, the traffic load is added, or the network or user sends a request, the cell selection process can be repeated. This is called a cell reselection procedure.

Further, if frequency interference occurs in a reception signal of a cell whose reception signal intensity is weak, that is, a cell whose communication channel state is not good, intensity of a reception signal can become temporarily high. When performing the cell selection or cell reselection procedure, the portable terminal may select a cell whose reception signal intensity became temporarily high due to frequency interference as a serving cell. In this case, the portable terminal can temporarily fall into a no service state. The portable terminal can reselect a serving cell using previously stored candidate cell (near cell and far cell) information in order to get out of the no service state. At this time, according to the conventional cell selection method, a serving cell where no-service state has occurred due to the bad communication channel state is registered as a candidate cell (e.g. far cell). Thereafter, the portable terminal may reselect the cell whose communication channel state is not good as a serving cell due to the intensity of the reception signal of the cell whose communication channel state is not good. That is, the conventional cell selection method has a problem in that temporary no-service phenomenon of a portable terminal is repeated, and, when the no-service phenomenon is generated, the portable terminal performs a cell selection procedure, thereby increasing battery current consumption.

### SUMMARY OF THE INVENTION

To address the above-discussed deficiencies of the prior art, it is a primary object to provide a method and apparatus for selecting a cell, which is capable of reducing temporary no service phenomenon by selecting a serving cell to be camped on, excluding a cell where frequency interference or a bad frame is generated, that is, a cell whose communication channel state is not good, and reducing battery current consumption due to frequent performance of cell selection procedure.

In accordance with an aspect of the present invention, a method of selecting a cell of a portable terminal for connecting to a communication network includes: setting a specific cell that satisfies preset conditions among surrounding cells of the portable terminal as a management cell; determining whether at least one of a cell selection and cell reselection event is generated; and performing a cell selection procedure excluding the management cell when at least one of the cell selection and cell reselection event is generated.

In accordance with another aspect of the present invention, an apparatus for selecting a cell of a portable terminal for connecting to a communication network includes a storage unit configured to store a management cell that satisfies preset conditions among a cell around the portable terminal, a serving cell to be camped on, and a candidate cell positioned near the serving cell; a controller configured to select a serving cell by performing a cell selection procedure, excluding the management cell when at least one of the cell selection and cell reselection event occurs; and a wireless communication unit configured to form a communication channel with the serving cell selected under the control of the controller.

In accordance with another aspect of the present invention, A portable terminal capable of selecting a cell for connecting to a communication network includes a storage unit configured to store a management cell that satisfies a preset condition among a cell around the portable terminal, a serving cell to be camped on, and a candidate cell positioned near the serving cell; a controller configured to select a serving cell by performing a cell selection procedure, excluding the management cell when at least one of the cell selection and cell reselection event occurs; and a wireless communication unit configured to form a communication channel with the serving cell selected under the control of the controller.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a method of selecting a cell according to an exemplary embodiment of the present invention;

FIG. 2 illustrates a method of setting a management cell according to an exemplary embodiment of the present invention;

FIG. 3 illustrates a method of cancelling a management cell according to an exemplary embodiment of the present invention; and

FIG. 4 illustrates a schematic configuration of a portable terminal according to an exemplary embodiment of the present invention.

### DETAILED DESCRIPTION OF THE INVENTION

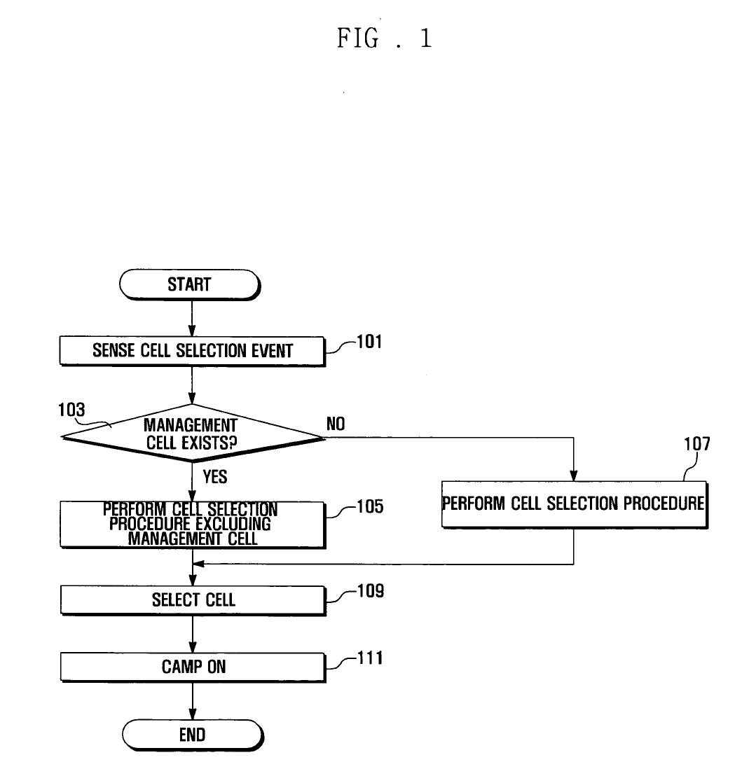

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

In the meantime, it is to be understood that the following disclosure is provided for exemplary purposes only and is not intended as a limitation of the present invention. Furthermore, all alternate embodiments which are obvious modifications of this disclosure are intended to be encompassed within the scope of the present invention.

Hereinafter, “serving cell” refers to a cell where a portable terminal and a base station form a communication channel. That is, it is a cell on which a portable terminal camps.

Hereinafter, “management cell” refers to a cell which is excluded when a cell is selected or reselected, and may refer to a cell which satisfies preset conditions, that is, a cell whose communication channel state is considered not good.

The present invention relates to a method and apparatus for selecting a cell. Particularly, an exemplary embodiment of the present invention provides a method and apparatus for selecting a cell, which can reduce the number of times of temporary no service occurrence, thereby reducing current consumption of a portable terminal by excluding a cell whose communication channel state is not good due to frequency interference or the like when selecting or reselecting a cell. To this end, a portable terminal according to an exemplary embodiment of the present invention can store surrounding cell information. Particularly, a portable terminal can set a specific cell that satisfies a preset condition, that is, a cell whose communication channel state is not good, among surrounding cells as a management cell, and can store the cell.

Hereinafter, a detailed operation of a portable terminal according to an exemplary embodiment of the present invention will be explained with reference to the attached drawings.

Before a detailed explanation, briefly explaining a cell selection procedure of a communication system, a portable terminal can search surrounding frequencies when power is turned on, and can select a serving cell according to intensity of a reception cell. Thereafter, the portable terminal can receive near cell and far cell information through a system information message that is periodically transmitted by a network where a communication channel is formed. Thereafter, in case the serving cell is missed due to a weakened reception signal or an error of the serving cell, the portable terminal can try connection to a communication network using the near cell and far cell information. Hereinafter, both the near cell and the far cell are called a candidate cell.

FIG. 1 illustrates a method of selecting a cell according to an exemplary embodiment of the present invention.

Referring to FIG. 1, the portable terminal can sense a cell selection event (step 101). The cell selection event may include a cell selection event when power of the portable terminal is turned on, a cell reselection event that a cell is reselected as a connection to a network connected to the portable terminal is cancelled, and a cell selection event according to hand-off of the portable terminal. Hereinafter, both “cell selection” and “cell reselection” will be called “cell selection” for the convenience of illustration.

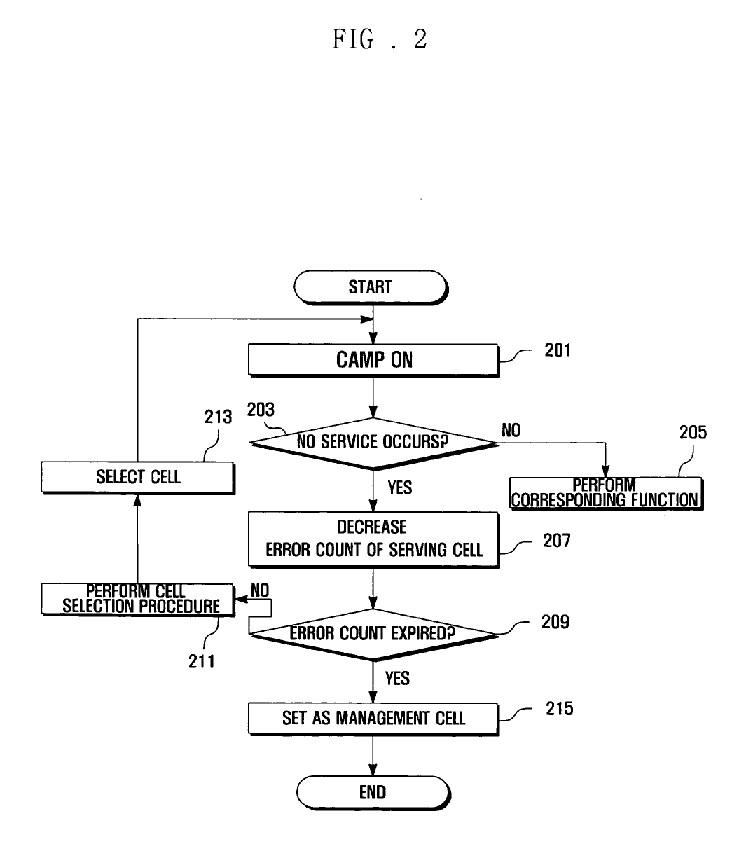

Thereafter, the portable terminal can check whether a management cell exists (step 103). The management cell is a cell whose communication channel state is not good, and refers to a cell where the number of times of no service occurrence exceeded a predefined number when the cell was selected as a serving cell, which will be explained later in more detail with reference to FIG. 2.

If at least one management cell exists at step 103, the portable terminal can perform a cell selection procedure, excluding the management cell (step 105). The cell selection procedure follows the mobile communication standards, and its detailed explanation will be omitted here. Briefly explaining, the cell selection procedure can be a process of extracting valid frequencies by searching surrounding frequencies, and selecting a channel corresponding to a frequency having highest reception signal intensity. In contrast, if a management cell does not exist at step 103, the portable terminal can perform a cell selection procedure for the entire cells (step 107). That is, a portable terminal can full-scan surrounding frequencies.

Thereafter, the portable terminal can select a cell to be camped on, that is, a serving cell, using cell information searched at step 105 or step 107 (step 109), and can camp on the selected serving cell (step 111).

Hence, according to the present invention, it is possible to be connected to a communication network using a cell whose communication channel state is good by excluding a management cell whose communication channel state is not good when selecting a cell. This can prevent a portable terminal from falling into a temporary no service state due to frequency interference or the like.

Until now, a cell selection method according to an exemplary embodiment of the present invention is explained. Hereinafter, a method for setting and cancelling the management cell according to the present invention will be explained.

FIG. 2 illustrates a method of setting a management cell according to an exemplary embodiment of the present invention.

Referring to FIG. 2, the portable terminal can camp on the selected serving cell according to the cell selection procedure (step 201). Thereafter, the portable terminal can check whether no service phenomenon has occurred (step 203). The no service phenomenon can occur due to frequency interference, bad frame generation, or the like. For example, a no service phenomenon can more probably occur when a cell, whose reception signal intensity is temporarily high due to frequency interference or the like even though the actual reception signal intensity is weak, is selected as a serving cell, that is, in case a cell whose reception signal is strong but whose channel state is not good is selected as a serving cell.

If a no-service phenomenon does not occur at step 203, the portable terminal can perform a corresponding function (step 205). For example, the portable terminal can perform a voice call function, a music playing function, and the like. Alternatively, if a no-service phenomenon occurs at step 203, the portable terminal can decrease an error count of a serving cell which is being connected at the no-service occurrence (step 207), and can check whether the error count is expired (step 209). To this end, a portable terminal according to the present invention can add error count information, which means the number of times of no-service occurrence, to each cell information.

If the error count is expired at step 209, the portable terminal can set the serving cell as a management cell (step 215). For example, if the error count information is set to ‘3,’ the portable terminal can decrease the error count by ‘1’ whenever the no-service phenomenon occurs; and if the error count becomes ‘0,’ the portable terminal can determine that the communication channel state of the cell is not good, so that the portable terminal can set the cell as a management cell. The number of times of the error count can vary depends on a design configuration or network environment.

Alternatively, if the error count is not expired at step 209, the portable terminal can perform a cell selection procedure (step 211), can select a cell to be camped on, and can camp on the selected cell (step 213).

Further, it was explained above that in case the error count is expired by decreasing the error count of the serving cell when no service occurs, the serving cell is set as a management cell, but the present invention is not limited to this example. For example, the present invention can increase the error count of the serving cell when no service occurs, and can set the serving cell as a management cell when the error count reaches a preset value.

Also, though not illustrated in FIG. 2, a process for checking intensity of a reception signal of a serving cell camped on before step 203 may be further included. Thereafter, the following process of step 203 to step 215 can be set to be performed when intensity of the reception signal of the serving cell is a preset value (e.g., −85 dBm) or more. This is for distinguishing a natural no service phenomenon that is generated because a reception signal is weak from a no service phenomenon of the present invention that is generated because a reception signal is strong but the channel state is not good due to frequency interference.

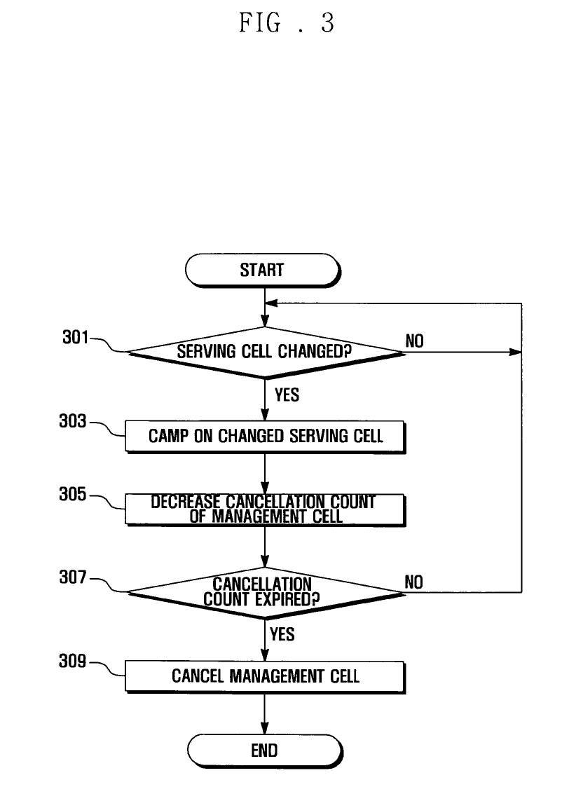

The state of the communication channel can be changed according to the position of a portable terminal, so that the error count can be initialized when the base station is changed, that is, the cell ID (identification) is changed. Also, the setting of the management cell can be cancelled when a serving cell is changed more than a preset number or when the base station is changed. The details will be explained later with reference to FIG. 3.

FIG. 3 illustrates a method of cancelling a management cell according to an exemplary embodiment of the present invention.

Referring to FIG. 3, the portable terminal can check whether a serving cell is changed (step 301). At this time, if the serving cell is not changed, the portable terminal can maintain step 301. Alternatively, if the serving cell is changed at step 301, the portable terminal can camp on the changed serving cell (step 303).

Thereafter, the portable terminal can decrease the cancellation count of the management cell (step 305), and can check whether the cancellation count is expired (step 307).

If the cancellation count is not expired at step 307, the portable terminal can return back to step 301, and repeat the above-described process. Alternatively, if the cancellation count is expired at step 307, the portable terminal can cancel the cell, whose cancellation count is expired, from the management cell (step 309).

Further, it was explained in the above that when the cancellation count is decreased to be expired, the setting of the management cell is cancelled, but the present invention is not limited to this. In contrast, the present invention can increase the cancellation count when the serving cell is changed, and if the cancellation count becomes more than a preset value, can cancel the setting of the management cell.

Also, it is possible to check cell ID received from the base station, and cancel the setting of the management cell when the cell ID is changed. This is because the communication channel can vary, depending on the base station.

Until now, a method of selecting a cell according to an exemplary embodiment of the present invention is explained. Hereinafter, a configuration of a portable terminal according to an exemplary embodiment of the present invention will be explained.

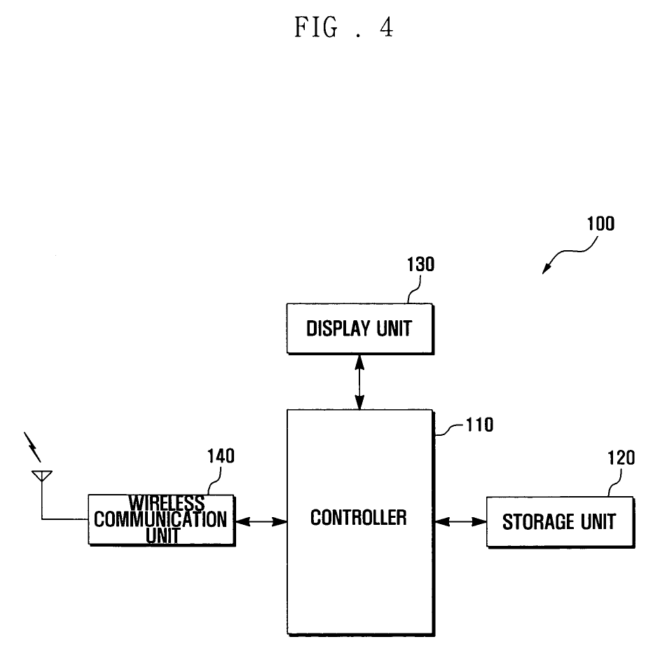

FIG. 4 schematically illustrates a configuration of a portable terminal 100 according to an exemplary embodiment of the present invention.

Referring to FIG. 4, a portable terminal according to an exemplary embodiment of the present invention can include a wireless communication unit 140, a display unit 130, a storage unit 120 and a controller 110. Hereinafter, each of these elements will be explained in detail.

The wireless communication unit 140 can form a communication channel with a base station and perform data and voice communication under the control of the controller 110. The wireless communication unit 140 can receive system information 2 (hereinafter, SI2) periodically transmitted by a communication network to which the portable terminal 100 belongs. The SI2 may include candidate cell (near cell and far cell) information. Hence, in case the SI2 is received through the wireless communication unit 140, the controller 110 can extract the candidate cell (near cell and far cell) information from the SI2, and store the extracted information in the storage unit 120. Particularly, the wireless communication unit 140 according to the present invention can perform a search of a frequency, excluding a cell that satisfies a preset condition among surrounding cells, that is, a management cell that is a specific cell whose communication channel environment is not good, when selecting a cell under the control of the controller 110.

The display unit 130 can display various menu screens of a portable terminal 100, user data inputted by user, function setting information or various information provided to user. The display unit 130 can be formed of a liquid crystal display (LCD), an organic light emitting diode (OLED), and the like. Further, if the display unit 130 is formed of a touch screen, it can be operated as an input unit (not shown).

The storage unit 120 can store user data generated by user, data transmitted and received during communication as well as application programs that are necessary for operating functions according to an exemplary embodiment of the present invention. Such a storage unit 120 can include a program area and a data area.

The program area can store an operation system, application programs necessary for the portable terminal. Particularly, the program area according to an exemplary embodiment of the present invention can include an application program for setting and cancelling a management cell, and a program for performing a cell selection procedure according to an exemplary embodiment of the present invention.

The data area can store user-related data of the portable terminal 100 and the like. Particularly, the data area according to the present invention can store cell information. The cell information can be classified into a serving cell camped on by a portable terminal, a near cell positioned near the serving cell, a far cell positioned far from the serving cell compared with the near cell, and a management cell whose communication channel state is not good, and can be separately stored. Also, each cell information can include error count information for setting a management cell and cancellation count information for cancelling the setting of a management cell. Also, the data area can store a reference value for determining the performing of an error count.

The controller 110 can control overall operations of a portable terminal 100 and a signal flow between internal blocks of the portable terminal 100, and can include the function of a data processing unit which processes data transmitted and received through the wireless communication unit 140. Particularly, a controller 110 according to the present invention can control a cell selection procedure. In more detail, when a cell selection or cell reselection event occurs, the controller 110 can check whether the management cell exists, select a serving cell among cells excluding the management cell, and camp on the selected serving cell. The management cell is excluded as it is highly probable that temporary no service occurs due to frequency interference or the like in case a cell whose communication state is not good is selected as a serving cell.

In addition, the controller 110 can control the process of setting a management cell. In more detail, the controller 110 can decrease the error count included in the serving cell information when no service occurs, and can set the serving cell as a management cell when the error count is expired. At this time, the controller 110 can check intensity of the reception signal of the serving cell, and can decrease the error count if the intensity is a preset value (e.g., −85 dBm) or more. This is for distinguishing a no service phenomenon that occurs in a weak electric field area where intensity of a reception signal is weak from a temporary no service phenomenon that occurs by being connected to a cell where intensity of a reception signal becomes high due to frequency interference.

The controller 110 can initialize the error count when the base station is changed, that is, the cell ID is changed. This is because the channel environment can vary depending on the base station.

Additionally, the controller 110 can control the process of cancelling the management cell. To this end, the controller 110 can decrease the cancellation count when a serving cell is changed, and can cancel the setting of the management cell when the cancellation count is expired. Alternatively, the controller 110 can cancel the setting of the management cell when the base station, that is, the cell ID, is changed. This is because the channel environment can vary depending on the base station.

Additionally, though not illustrated in FIG. 4, the portable terminal 100 can further include a camera module for taking an image or video, a broadcast reception module for receiving a broadcast, an audio signal output device such as a speaker, a voice signal input device such as a microphone, and a digital sound source playing module such as an MP3 module. These elements can be variously modified according to convergence trend of digital devices, so that all these elements cannot be listed here, but a portable terminal 100 according to the present invention can further include other elements which are similar to the above-mentioned elements in configuration.

The present invention can reduce a temporary no service phenomenon that can occur when a portable terminal camps on a management cell by setting as a management cell at least one cell whose communication channel state is not good due to frequency interference, bad frame generation or the like even though intensity of a reception signal is high, and excluding the management cell in the process of selecting a cell, and can minimize battery current consumption due to frequent cell selection procedures, thereby improving user's convenience. In addition, the present invention can improve user's convenience by reducing call disconnection, or non-availability of outgoing calls due to temporary no service.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of selecting a cell of a portable terminal for connecting to a communication network, the method comprising:
setting a specific cell that satisfies a preset condition among surrounding cells of the portable terminal as a management cell;
determining whether at least one of cell selection and cell reselection event is generated; and
performing a cell selection procedure excluding the management cell when the at least one of the cell selection and the cell reselection event is generated.

2. The method of claim 1, wherein setting a specific cell as a management cell comprises:
checking whether a no service phenomenon occurs;
counting a number of times of no service occurrence of a serving cell that is being connected when the no service phenomenon occurs; and
setting the serving cell as the management cell if the number of times of no service occurrence of the serving cell equals at least a preset value.

3. The method of claim 2, further comprising:
checking whether intensity of a reception signal of the serving cell is a preset value or more before checking whether the no service phenomenon occurs; and
setting the serving cell as the management cell if intensity of the reception signal of the serving cell is a preset value or more.

4. The method of claim 1, further comprising:
checking whether the serving cell is changed;
camping on a serving cell if the serving cell is changed, and counting the number of times of the change of the serving cell; and

5. The method of claim 4, wherein counting the number of times of the change of the serving cell further comprising:
decreasing a cancellation count of the management cell.

6. The method of claim 5, further comprising:
cancelling the management cell setting if the count is expired.

7. An apparatus for selecting a cell of a portable terminal for connecting to a communication network, the apparatus comprising:
a storage unit configured to store a management cell that satisfies a preset condition among a cell around the portable terminal, a serving cell to be camped on, and a candidate cell positioned near the serving cell;
a controller configured to select a serving cell by performing a cell selection procedure, excluding the management cell when at least one of the cell selection and cell reselection event occurs; and
a wireless communication unit configured to form a communication channel with the serving cell selected under the control of the controller.

8. The apparatus of claim 7, wherein the controller is configured to count a number of times of no service occurrence of the serving cell when a no service phenomenon occurs, and set the serving cell as a management cell if the number of times of the no service occurrence is a preset value or more.

9. The apparatus of claim 8, wherein the controller is configured to check an intensity of a reception signal of the serving cell, and count the number of times of the no service occurrence if the no service occurs when intensity of the reception signal is at least a preset value.

10. The apparatus of claim 7, wherein the controller is configured to count a cancellation count stored in the management cell when the serving cell is changed, and cancel the management cell setting when the cancellation count is expired.

11. The apparatus of claim 10, wherein the controller initializes the number of times of the no service occurrence of the serving cell when a base station is changed.

12. The apparatus of claim 10, wherein the controller initializes the management cell setting when the base station is changed.

13. A portable terminal capable of selecting a cell for connecting to a communication network, the portable terminal comprising:
a storage unit configured to store a management cell that satisfies a preset condition among a cell around the portable terminal, a serving cell to be camped on, and a candidate cell positioned near the serving cell;
a controller configured to select a serving cell by performing a cell selection procedure, excluding the management cell when at least one of the cell selection and cell reselection event occurs; and
a wireless communication unit configured to form a communication channel with the serving cell selected under the control of the controller.

14. The portable terminal of claim 13, wherein the controller is configured to count a number of times of no service occurrence of the serving cell when a no service phenomenon occurs, and set the serving cell as a management cell if the number of times of the no service occurrence is a preset value or more.

15. The portable terminal of claim 14, wherein the controller is configured to check an intensity of a reception signal of the serving cell, and count the number of times of the no service occurrence if the no service occurs when intensity of the reception signal is at least a preset value.

16. The portable terminal of claim 13, wherein the controller is configured to count a cancellation count stored in the management cell when the serving cell is changed.

17. The portable terminal of claim 16, wherein the controller is configured to decrease a cancellation count of the management cell.

18. The portable terminal of claim 17, wherein the controller is configured to cancel the management cell setting when the cancellation count is expired.

19. The portable terminal of claim 16, wherein the controller initializes the number of times of the no service occurrence of the serving cell when a base station is changed.

20. The portable terminal of claim 16, wherein the controller initializes the management cell setting when the base station is changed.
